(19) United States
(12) Patent Application Publication
(10) Pub. No.: US 2019/0251071 A1
(43) Pub. Date: Aug. 15, 2019

(54) BLOCKCHAIN DATA RELATIONSHIP STRUCTURING SCHEME BASED ON BINARY LOG REPLICATION

(71) Applicant: Alibaba Group Holding Limited, George Town (KY)

(72) Inventors: Kailai Shao, Hangzhou (CN); Xuming Lu, Hangzhou (CN); Pengtao Qi, Hangzhou (CN)

(73) Assignee: Alibaba Group Holding Limited, George Town (KY)

(21) Appl. No.: 16/390,873

(22) Filed: Apr. 22, 2019

Related U.S. Application Data
(63) Continuation of application No. PCT/CN2018/118369, filed on Nov. 30, 2018.

(51) Int. Cl. G06F 16/23; H04L 9/06; G06Q 20/40; G06F 16/248; G06Q 20/36

(52) U.S. Cl. CPC G06F 16/2358; H04L 9/0637; G06Q 20/3672; G06F 16/248; G06Q 20/405

(57) ABSTRACT

Implementations of the present specification include polling the blockchain at specified time intervals, receiving block information from one or more updated blocks, the block information including static information and dynamic information, the dynamic information including one or more variables to be used in a smart contract, converting the dynamic information into one or more binary logs, and updating the local database using the one or more binary logs.

### CROSS-REFERENCE TO RELATED APPLICATIONS

This application is a continuation of PCT Application No. PCT/CN2018/118369, filed on Nov. 30, 2018, which is hereby incorporated by reference in its entirety.

### BACKGROUND

Distributed ledger systems (DLSs), which can also be referred to as consensus networks, and/or blockchain networks, enable participating entities to securely, and immutably store data. DLSs are commonly referred to as blockchain networks without referencing any particular use case (e.g., crypto-currencies). Example types of blockchain networks can include public blockchain networks, private blockchain networks, and consortium blockchain networks. A public blockchain network is open for all entities to use the DLS, and participate in the consensus process. A private blockchain network is provided for a particular entity, which centrally controls read and write permissions. A consortium blockchain network is provided for a select group of entities, which control the consensus process, and includes an access control layer.

Information recorded on a blockchain can be viewed using third-party blockchain browsers. The third-party blockchain browsers can return static information on a blockchain such as the balance of individual accounts, transaction history, and smart contract terms, among other information. In some cases, however, a blockchain also contains dynamic data such as variables responsible for the execution of smart contracts. Traditional blockchain browsers do not have the capability to show such dynamic information.

### SUMMARY

Implementations of the present specification include computer-implemented methods for displaying dynamic information of a blockchain. More particularly, implementations of the present specification are directed to converting dynamic information in a blockchain into one or more binary logs, and updating a database using the binary logs.

In some implementations, actions include polling the blockchain at specified time intervals, receiving block information from one or more updated blocks, the block information including static information and dynamic information, the dynamic information including one or more variables to be used in a smart contract, converting the dynamic information into one or more binary logs, and updating the local database using the one or more binary logs. Other implementations include corresponding systems, apparatus, and computer programs, configured to perform the actions of the methods, encoded on computer storage devices.

These and other implementations may each optionally include one or more of the following features: the one or more binary logs are stored in a binary log file separate from the local database; the local database is a relational database; the one or more binary logs are written in accordance with structured query languages; the polling of the blockchain is triggered by an execution of the smart contract; actions further include updating the local database using the static information; and actions further include, in response to a user query to the local database, presenting the dynamic information to a user device.

The present specification also provides one or more non-transitory computer-readable storage media coupled to one or more processors and having instructions stored thereon which, when executed by the one or more processors, cause the one or more processors to perform operations in accordance with implementations of the methods provided herein.

The present specification further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the present specification are set forth in the accompanying drawings and the description below. Other features and advantages of the present specification will be apparent from the description and drawings, and from the claims.

### DESCRIPTION OF DRAWINGS

FIG. 1 depicts an example environment that can be used to execute implementations of the present specification.

FIG. 2 depicts an example conceptual architecture in accordance with implementations of the present specification.

FIG. 3 depicts an example system that can be used to display blockchain dynamic data using binary logs in accordance with implementations of the present specification.

FIG. 4 depicts an example process that can be executed in accordance with implementations of the present specification.

Like reference symbols in the various drawings indicate like elements.

### DETAILED DESCRIPTION

Implementations of the present specification include computer-implemented methods for replicating blockchain data using binary logs. More particularly, implementations of the present specification are directed to converting smart contract information into binary logs and updating a relational database using the binary logs. In some implementations, actions include polling the blockchain at specified time intervals, receiving block information from one or more updated blocks, the block information including static information and dynamic information, the dynamic information including one or more variables to be used in a smart contract, converting the dynamic information into one or more binary logs, and updating the local database using the one or more binary logs.

To provide further context for implementations of the present specification, and as introduced above, distributed ledger systems (DLSs), which can also be referred to as consensus networks (e.g., made up of peer-to-peer nodes), and blockchain networks, enable participating entities to securely, and immutably conduct transactions, and store data. Although the term blockchain is generally associated with a crypto-currency network, blockchain is used herein to generally refer to a DLS without reference to any particular use case. As introduced above, a blockchain network can be provided as a public blockchain network, a private blockchain network, or a consortium blockchain network.

In a public blockchain network, the consensus process is controlled by nodes of the consensus network. For example, hundreds, thousands, even millions of entities can cooperate a public blockchain network, each of which operates at least one node in the public blockchain network. Accordingly, the public blockchain network can be considered a public network with respect to the participating entities. In some examples, a majority of entities (nodes) must sign every block in order for the block to be valid, and added to the blockchain (distributed ledger) of the blockchain network. An example public blockchain network includes particular crypto-currency networks, which are provided as peer-to-peer payment networks, which leverage distributed ledgers, referred to as blockchains. As noted above, the term blockchain, however, is used to generally refer to distributed ledgers without reference to any particular crypto-currency network.

In general, a public blockchain network supports public transactions. A public transaction is shared with all of the nodes within the public blockchain network, and are stored in a global blockchain. A global blockchain is a blockchain that is replicated across all nodes. That is, all nodes are in perfect state consensus with respect to the global blockchain. To achieve consensus (e.g., agreement to the addition of a block to a blockchain), a consensus protocol is implemented within the public blockchain network. An example consensus protocol includes, without limitation, proof-of-work (POW) implemented in particular crypto-currency networks.

In general, a private blockchain network private blockchain network is provided for a particular entity, which centrally controls read and write permissions. The entity controls, which nodes are able to participate in the blockchain network. Consequently, private blockchain networks are generally referred to as permissioned networks that place restrictions on who is allowed to participate in the network, and on their level of participation (e.g., only in certain transactions). Various types of access control mechanisms can be used (e.g., existing participants vote on adding new entities, a regulatory authority can control admission).

In general, a consortium blockchain network is private among the participating entities. In a consortium blockchain network, the consensus process is controlled by an authorized set of nodes, one or more nodes being operated by a respective entity (e.g., a financial institution, insurance company). For example, a consortium of ten (10) entities (e.g., financial institutions, insurance companies) can operate a consortium blockchain network, each of which operates at least one node in the consortium blockchain network. Accordingly, the consortium blockchain network can be considered a private network with respect to the participating entities. In some examples, each entity (node) must sign every block in order for the block to be valid, and added to the blockchain. In some examples, at least a sub-set of entities (nodes) (e.g., at least 7 entities) must sign every block in order for the block to be valid, and added to the blockchain.

Implementations of the present specification are described in further detail herein with reference to a public blockchain network, which is public among the participating entities. It is contemplated, however, that implementations of the present specification can be realized in any appropriate type of blockchain network.

Implementations of the present specification are described in further detail herein in view of the above context. More particularly, and as introduced above, implementations of the present specification are directed to displaying dynamic information such as smart contact variables of a blockchain. In accordance with implementations of the present specification, instructions to update dynamic information on a blockchain, such as during the execution of a smart contract, are converted into binary logs compatible with structured query languages. The binary logs are used to update a database storing a state of the blockchain. A user can query the database (e.g., using SQL queries) to view data associated with the blockchain.

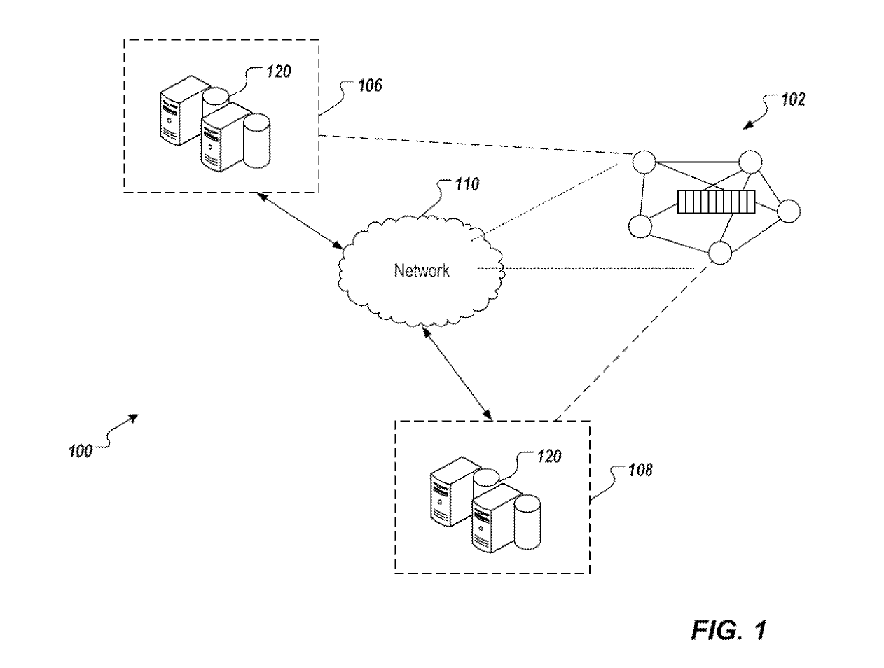

FIG. 1 depicts an example environment 100 that can be used to execute implementations of the present specification. In some examples, the example environment 100 enables entities to participate in a public blockchain network 102. The example environment 100 includes computing devices 106, 108, and a network 110. In some examples, the network 110 includes a local area network (LAN), wide area network (WAN), the Internet, or a combination thereof, and connects websites, user devices (e.g., computing devices), and back-end systems. In some examples, the network 110 can be accessed over a wired and/or a wireless communications link.

In the depicted example, the computing systems 106, 108 can each include any appropriate computing system that enables participation as a node in the public blockchain network 102. Example computing devices include, without limitation, a server, a desktop computer, a laptop computer, a tablet computing device, and a smartphone. In some examples, the computing systems 106, 108 hosts one or more computer-implemented services for interacting with the public blockchain network 102. For example, the computing system 106 can host computer-implemented services of a first entity (e.g., user A), such as transaction management system that the first entity uses to manage its transactions with one or more other entities (e.g., other users). The computing system 108 can host computer-implemented services of a second entity (e.g., user B), such as transaction management system that the second entity uses to manage its transactions with one or more other entities (e.g., other users). In the example of FIG. 1, the public blockchain network 102 is represented as a peer-to-peer network of nodes, and the computing systems 106, 108 provide nodes of the first entity, and second entity respectively, which participate in the public blockchain network 102.

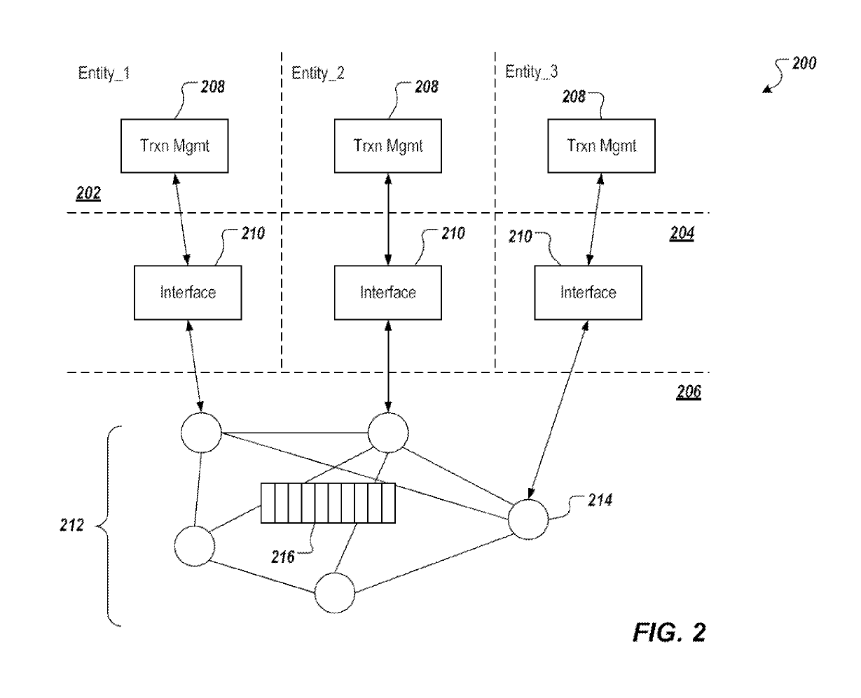

FIG. 2 depicts an example conceptual architecture 200 in accordance with implementations of the present specification. The example conceptual architecture 200 includes an entity layer 202, a hosted services layer 204, and a blockchain network layer 206. In the depicted example, the entity layer 202 includes three entities, Entity_1 (E1), Entity_2 (E2), and Entity_3 (E3), each entity having a respective transaction management system 208.

In the depicted example, the hosted services layer 204 includes interfaces 210 for each transaction management system 210. In some examples, a respective transaction management system 208 communicates with a respective interface 210 over a network (e.g., the network 110 of FIG. 1) using a protocol (e.g., hypertext transfer protocol secure (HTTPS)). In some examples, each interface 210 provides a communication connection between a respective transaction management system 208, and the blockchain network layer 206. More particularly, the interface 210 communicates with a blockchain network 212 of the blockchain network layer 206. In some examples, communication between an interface 210, and the blockchain network layer 206 is conducted using remote procedure calls (RPCs). In some examples, the interfaces 210 “host” blockchain network nodes for the respective transaction management systems 208. For example, the interfaces 210 provide the application programming interface (API) for access to blockchain network 212.

As described herein, the blockchain network 212 is provided as a peer-to-peer network including a plurality of nodes 214 that immutably record information in a blockchain 216. Although a single blockchain 216 is schematically depicted, multiple copies of the blockchain 216 are provided, and are maintained across the blockchain network 212. For example, each node 214 stores a copy of the blockchain. In some implementations, the blockchain 216 stores information associated with transactions that are performed between two or more entities participating in the public blockchain network.

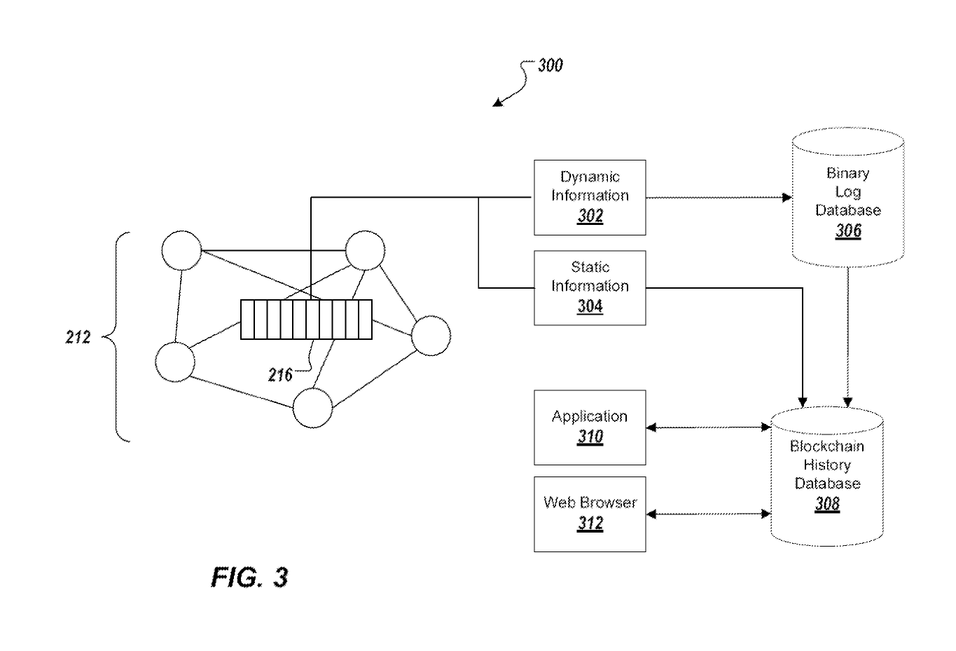

FIG. 3 depicts an example system 300 that can be used to provide blockchain dynamic data using binary logs. The system 300 can be a part of a larger computer environment (e.g., the system 100), or be a stand-alone system.

The system 300 is implemented to provide dynamic information maintained in a blockchain network (e.g., the blockchain network 212). As described in FIG. 2, the blockchain network 212 maintains the blockchain 216 with each computing node in the blockchain network 212 storing a copy of the blockchain 216. The blockchain 216 includes both static information 304 and dynamic information 302. For example, the blockchain 216 can include static information, which can include, without limitation, the addresses of individual accounts in the blockchain, the balance of individual accounts in the blockchain, smart contract addresses in the blockchain, and the like. Because the static information 302 is immutable once it is written to the blockchain, it can be directly polled and stored in a database for viewing. For example, the static information can be recorded in a blockchain history database 308. The blockchain history database 308 can be a relational database recording the blockchain state at different times. For example, a user wishing to know the balance of a blockchain address at a particular time can submit a query specifying the account address and the time to the blockchain history database 308 using an application 310, or a web browser 312. Allowing users to submit queries to the blockchain history database 308, as opposed to requiring the users to request information directly from the blockchain network 212, improves query lookup time and reduces bandwidth pressure on the blockchain network 212.

In addition to the static information, the blockchain 216 can include dynamic information that changes based on operations within the blockchain network 212. For example, dynamic information can include, without limitation, variables used in the execution of smart contracts on the blockchain 216. To record the dynamic information to the blockchain history database 308, the system 300 converts instructions that operate on the dynamic information into a structured query language, and stores the converted structured query language as binary logs in a binary log file 306. For example, the blockchain 216 can include a smart contract with the following statements:

```
Class DemoContract:
    def _init_(self):
        self.status= “init”
    def set_a_value (self, key, value):
          if key == “status”:
              self.status = value
```

The system 300 can convert these example statements into the following query languages to be added to the binary log file 306: “update contract set ‘status’=‘new_value’ where ‘contract_addr’=‘abcdefeas123343’.”

When the dynamic information is updated (e.g., by the execution of a smart contract), the binary log file 306 replicates the updated binary logs to the blockchain history database 308. As a result, the blockchain history database 308 includes the updated record of the dynamic information in the blockchain 216. An example of dynamic data stored in the blockchain history database 308 is shown in Table 1 below.

TABLE 1
Example Dynamic Data

| | | | | |
|---|---|---|---|---|
| contract_add | key | value | last_modified | . . . |

| | | | | |
|---|---|---|---|---|
| 23d61f4a88f90be12 | “status” | “new_value” | 2018 Aug. 1 | . . . |

| | | | | |
|---|---|---|---|---|
| | | | 15:19 | |
| 1290c0eeab344992 | “statusArray” | “[“value1”,“value2”]” | 2018 Aug. 7 | . . . |
| | | | 16:20 | |
| 290ca88f923d61f4a | “token” | “{ | 2018 Aug. 8 | . . . |

| | |
|---|---|
| “value” :2000 | 17:21 |
| “unit” : “RMB” | |

}”

To view the updated dynamic information, a user can submit a query (e.g., SQL query) to the blockchain history database 308 using the application 310, or the web browser 312.

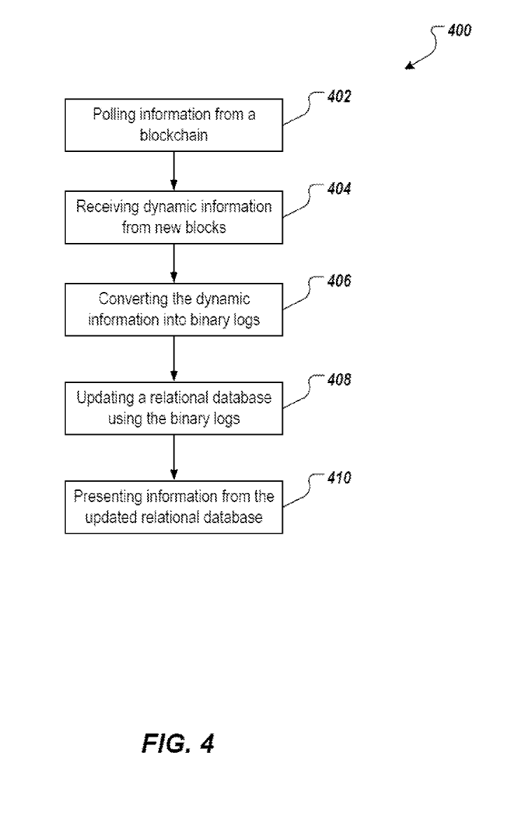

FIG. 4 depicts an example process 400 that can be executed in accordance with implementations of the present specification. In some implementations, the example process 400 may be performed by a system of one or more computer-executable programs executed using one or more computing devices (e.g., the system 300 of FIG. 3). For convenience, the process 400 will be described as being performed by the system.

The system polls information from a blockchain to receive updated information. For example, the system can poll the blockchain at specified time intervals, or the blockchain can notify the system when new transactions have been written to the blockchain. In some cases, the system can add a hook to functions that write to the blockchain (402).

After polling the blockchain, the system receives dynamic information such as new values produced by smart contracts executing on the blockchain (404).

The system converts the dynamic information into SQL compatible binary logs for storing in a log file (406). For example, a smart contract can be written in a specific programming language to set a particular variable. The system can convert the set function into a SQL query as described in FIG. 3 and the related descriptions.

The system updates a relational database using the binary logs (408). For example, the relational database can be set as a slave in a master/slave scheme to receive binary logs from the binary log file. In some cases, the polling of binary logs to the relational database can be done using a dedicated program running in the system.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or another unit suitable for use in a computing environment.

Suitable processors for the execution of a program of instructions include, by way of example, both general and special purpose microprocessors, and the sole processor or one of the multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by ways of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present specification have been described. Nevertheless, it will be understood that various modifications may be made without departing from the spirit and scope of the present specification. Accordingly, other implementations are within the scope of the following claims.

What is claimed is:

1. A computer-implemented method for replicating data from a blockchain to a local database, the method comprising:
polling the blockchain at specified time intervals;
receiving block information from one or more updated blocks, the block information comprising static information and dynamic information, the dynamic information comprising one or more variables to be used in a smart contract;
converting the dynamic information into one or more binary logs; and
updating the local database using the one or more binary logs.

2. The method of claim 1, wherein the one or more binary logs are stored in a binary log file separate from the local database.

3. The method of claim 1, wherein the local database is a relational database.

4. The method of claim 1, wherein the one or more binary logs are written in accordance with structured query languages.

5. The method of claim 1, wherein the polling of the blockchain is triggered by an execution of the smart contract.

6. The method of claim 1, further comprising updating the local database using the static information.

7. The method of claim 1, further comprising, in response to a user query to the local database, presenting the dynamic information to a user device.

8. A non-transitory, computer-readable medium storing one or more instructions executable by a computer system to perform operations for replicating data from a blockchain to a local database, the operations comprising:
polling the blockchain at specified time intervals;
receiving block information from one or more updated blocks, the block information comprising static information and dynamic information, the dynamic information comprising one or more variables to be used in a smart contract;
converting the dynamic information into one or more binary logs; and
updating the local database using the one or more binary logs.

9. The non-transitory, computer-readable medium of claim 8, wherein the one or more binary logs are stored in a binary log file separate from the local database.

10. The non-transitory, computer-readable medium of claim 8, wherein the local database is a relational database.

11. The non-transitory, computer-readable medium of claim 8, wherein the one or more binary logs are written in accordance with structured query languages.

12. The non-transitory, computer-readable medium of claim 8, wherein the polling of the blockchain is triggered by an execution of the smart contract.

13. The non-transitory, computer-readable medium of claim 8, the operations further comprising updating the local database using the static information.

14. The non-transitory, computer-readable medium of claim 8, the operations further comprising, in response to a user query to the local database, presenting the dynamic information to a user device.

15. A system for replicating data from a blockchain to a local database, comprising:
one or more computers; and
one or more computer-readable memories coupled to the one or more computers and having instructions stored thereon which are executable by the one or more computers to perform operations comprising:
polling the blockchain at specified time intervals;
receiving block information from one or more updated blocks, the block information comprising static information and dynamic information, the dynamic information comprising one or more variables to be used in a smart contract;
converting the dynamic information into one or more binary logs; and
updating the local database using the one or more binary logs.

16. The system of claim 15, wherein the one or more binary logs are stored in a binary log file separate from the local database.

17. The system of claim 15, wherein the local database is a relational database.

18. The system of claim 15, wherein the one or more binary logs are written in accordance with structured query languages.

19. The system of claim 15, wherein the polling of the blockchain is triggered by an execution of the smart contract.

20. The system of claim 15, the operations further comprising updating the local database using the static information.
